(19) United States
(12) Patent Application Publication
(10) Pub. No.: US 2016/0217227 A1
(43) Pub. Date: Jul. 28, 2016

(54) ADAPTIVE LOW POWER AND HIGH PERFORMANCE LOGIC DESIGN AND PHYSICAL DESIGN TECHNIQUES

(71) Applicant: QUALCOMM Incorporated, San Diego, CA (US)

(72) Inventors: Peeyush Kumar PARKAR, Bangalore KRN (IN); Vijayalakshmi RANGANNA, Bangalore KRN (IN); Animesh DATTA, San Diego, CA (US); Sachin BAPAT, Bangalore KRN (IN)

(21) Appl. No.: 14/603,281

(22) Filed: Jan. 22, 2015

(51) Int. Cl. G06F 17/50

(52) U.S. Cl. CPC G06F 17/505

(57) ABSTRACT

At least one critical path is determined of a plurality of paths in a network of logic elements. In addition, a plurality of original cells is determined in a critical path of the at least one critical path. Each intermediate output of the plurality of original cells is unconnected to any input external to the plurality of original cells. The plurality of original cells performs a particular logic function. Furthermore, the plurality of original cells are replaced with at least one replacement cell that performs the particular logic function. A number of cells of the at least one replacement cell is less than a number of cells of the plurality of original cells. The plurality of paths may be between a first memory stage and a second memory stage, and each of the at least one critical path may have a delay greater than a delay threshold.

### BACKGROUND

1. Field

The present disclosure relates generally to logic synthesis, and more particularly, to adaptive low power and high performance logic design and physical design techniques.

2. Background

In logic synthesis, desired circuit behavior through a register transfer level (RTL) description is translated into a design implementation of logic gates by a synthesis tool. Methods for improving logic synthesis are needed.

### SUMMARY

In an aspect of the disclosure, at least one critical path is determined of a plurality of paths in a network of logic elements. In addition, a plurality of original cells is determined in a critical path of the at least one critical path. Each intermediate output of the plurality of original cells is unconnected to any input external to the plurality of original cells. The plurality of original cells performs a particular logic function. Furthermore, the plurality of original cells are replaced with at least one replacement cell that performs the particular logic function. A number of cells of the at least one replacement cell is less than a number of cells of the plurality of original cells.

In an aspect of the disclosure, a metal oxide semiconductor (MOS) device includes a network of logic elements that includes a plurality of paths between memory stages. The MOS device further includes at least two cells that are configured together to perform a logic function. The at least two cells are in a first path of the plurality of paths of the network of logic elements. The first path is between a first set of memory stages. The MOS device further includes a cell that is configured to perform the same logic function as the at least two cells. The cell is in a second path of the plurality of paths of the network of logic elements. The second path is between a second set of memory stages.

### BRIEF DESCRIPTION OF THE DRAWINGS

FIG. 1 is a diagram for illustrating a plurality of paths including cells between memory stages.

FIGS. 2A, 2B, and 2C are a first set of diagrams for illustrating an exemplary method of logic synthesis.

FIGS. 3A and 3B are a second set of diagrams for illustrating an exemplary method of logic synthesis.

FIG. 4 is a first circuit diagram for illustrating an exemplary method of logic synthesis.

FIG. 5 is a second circuit diagram for illustrating an exemplary method of logic synthesis.

FIG. 6 is a flow chart of an exemplary method.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Apparatuses and methods will be described in the following detailed description and may be illustrated in the accompanying drawings by various blocks, modules, components, circuits, steps, processes, algorithms, elements, etc.

By way of example, an element, or any portion of an element, or any combination of elements may be implemented with one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

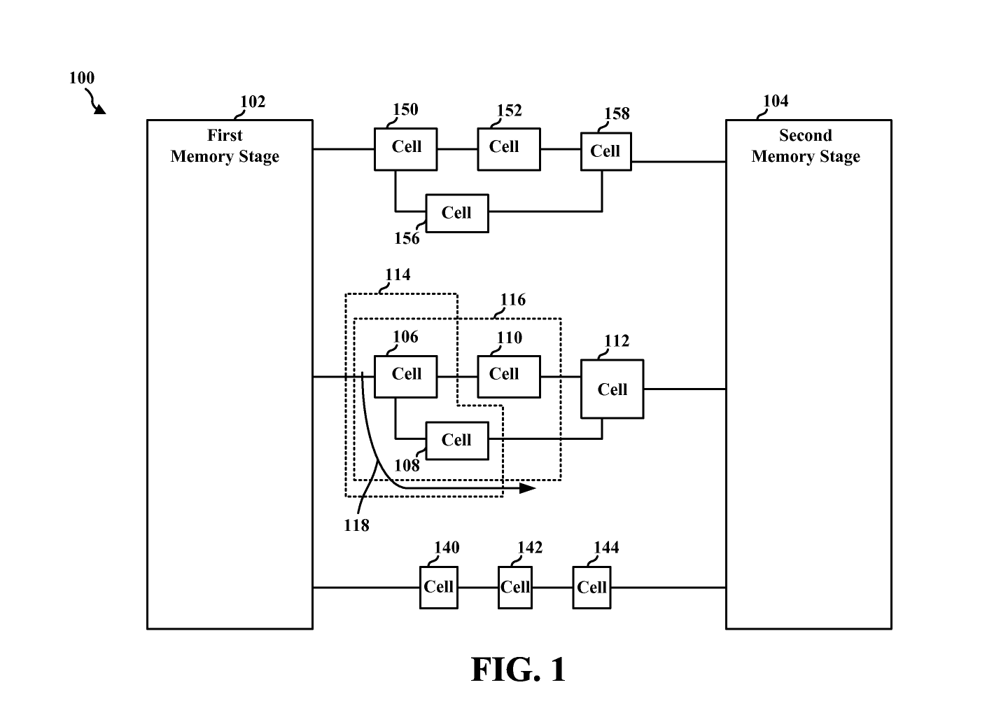

FIG. 1 is a diagram 100 for illustrating a plurality of paths including cells between memory stages. In logic synthesis, desired circuit behavior through an RTL description is translated into a design implementation of logic gates by a synthesis tool. A synthesis tool determines a network of logic elements based on the RTL description. For example, a synthesis tool may determine a network of logic elements includes the cells 106, 108, 110, 112, 140, 142, 144, 150, 152, 156, and 158. The cells may be referred to as standard cells. Subsequently, in exemplary configurations, the synthesis tool determines at least one critical path of a plurality of paths in the network of logic elements. The synthesis tool may determine at least one critical path between memory stages 102, 104 (as shown in FIG. 1), between a memory stage and a register (flip-flop, latch), between a register and a memory stage, between two registers, or between other elements in which a delay in the path between the elements may be critical to the proper operation of the integrated circuit (IC) including such elements. Referring to FIG. 1, the synthesis tool may determine that the plurality of paths include a first path including the cells 150, 152, 156, 158; a second path including the cells 106, 108, 110, 112; and a third path including the cells 140, 142, 144. The synthesis tool may determine that the path 118 within the second path is a critical path. The synthesis tool identified the path 118 as a critical path because the delay through the path 118 is greater than a delay threshold, and a decrease of the delay through the path 118 would decrease the time for signals to propagate from the first memory stage 102 to the second memory stage 104 through the cell 112 (which may have a signal from cell 110, but be waiting for the signal from the cell 108). Within the critical path 118, the synthesis tool determines a plurality of original cells that are in the critical path 118. For example, the synthesis tool may determine that cells 106 and 108 (enclosure 114) are in the critical path 118. Subsequently, the synthesis tool replaces the original cells 106 and 108 with at least one replacement cell that performs the same logic function as the cells 106 and 108. The at least one replacement cell may include less cells than the original cells 106 and 108, and therefore because the original cells 106 and 108 are two cells, the at least one replacement cell may be one cell. In some configurations, the synthesis tool may also replace additional cells in a non-critical path, when replacing cells. For example, the synthesis tool may replace the cells 106, 108, and 110 (enclosure 116) with at least one replacement cell that performs the same logic function as the cells 106, 108, and 110. Through the replacement, a delay through the critical path 118 is decreased, as the delay through the at least one replacement cell is less than a delay through the original cells 106 and 108.

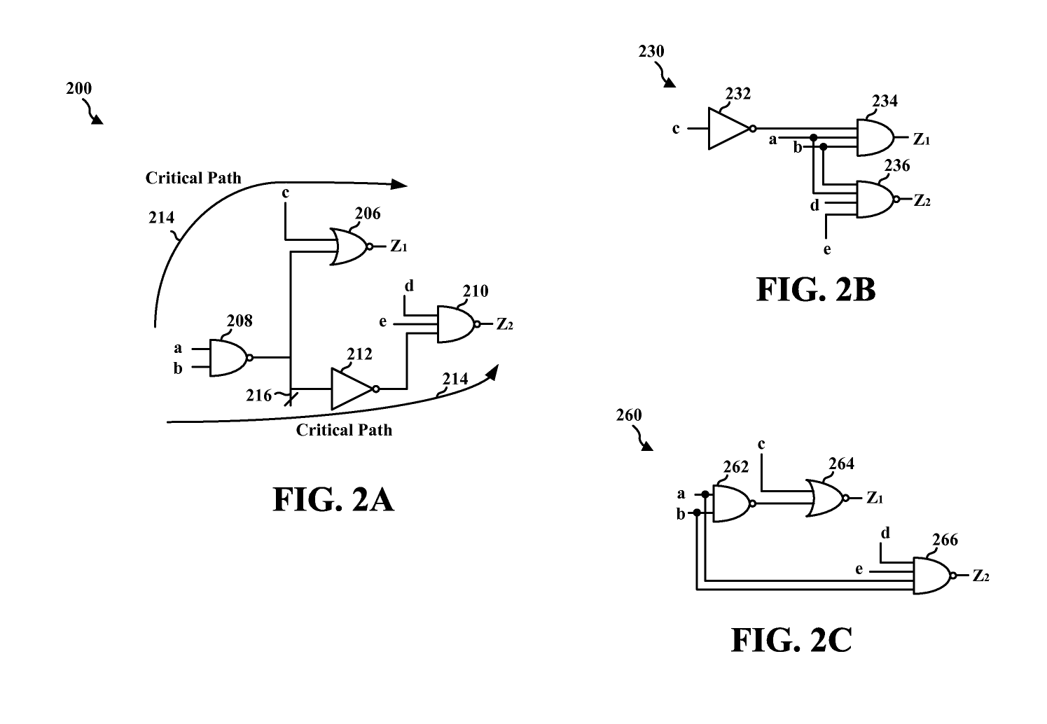

FIGS. 2A, 2B, and 2C are a first set of diagrams 200, 230, 260 for illustrating an exemplary method of logic synthesis. As discussed supra, a synthesis tool determines at least one critical path of a plurality of paths in a network of logic elements. For example, referring to FIG. 2A, the synthesis tool may determine that the path 214 through the NAND gate 208, inverter 212, and NAND gate 210 and through the NAND gate 208 and NOR gate 206 is a critical path. The synthesis tool determines that the plurality of original cells 208, 206, 212, and 210 are in the critical path 214. The synthesis tool may then determine whether any intermediate outputs (e.g., 216) of the original cells 208, 206, 212, and 210 are connected to any inputs external to the original cells 208, 206, 212, and 210. Specifically, the synthesis tool determines whether the original cells 208, 206, 212, and 210 have any fan out of intermediate outputs that are connected to inputs external to the original cells 208, 206, 212, and 210. If the synthesis tool determines that no intermediate outputs of the original cells 208, 206, 212, and 210 are connected to inputs external to the original cells 208, 206, 212, and 210, the synthesis tool may replace the original cells 208, 206, 212, and 210 with at least one replacement cell that performs the same logic function as the original cells 208, 206, 212, and 210 (Z₁=a̅b̅+̅c̅; Z₂=a̅b̅d̅e̅) and has less propagation delay for the critical path than the original cells 208, 206, 212, and 210.

A number of cells of the at least one replacement cell may be less than a number of cells of the original cells. Further, a size (height*width) of the at least one replacement cell may be less than or equal to a combined size of the original cells 208, 206, 212, and 210 so that the at least one replacement cell can replace the original cells 208, 206, 212, and 210 without redesigning cells adjacent to the original cells 208, 206, 212, and 210. Further, the height of the at least one replacement cell may be the same height as each of the original cells 208, 206, 212, and 210 so that the at least one replacement cell may be located in the same area as the original cells 208, 206, 212, and 210 without redesigning cells adjacent to the original cells 208, 206, 212, and 210. When the number of cells of the at least one replacement cell is less than the number of cells of the original cells 208, 206, 212, and 210, the at least one replacement cell may be more compact that the original cells 208, 206, 212, and 210, and therefore may have a smaller size than the original cells 208, 206, 212, and 210.

The at least one replacement cell has less propagation delay for at least some sub-paths (including the critical path) through the at least one replacement cell. For example, referring to FIG. 2B, the synthesis tool may replace the original cells 208, 206, 212, and 210 (four cells) with one to three cells that include the inverter 232, AND gate 234, and NAND gate 236 interconnected as shown in the diagram 230. The inverter 232, AND gate 234, and NAND gate 236 in the at least one replacement cell may have a size less than or equal to the size of the original cells 208, 206, 212, and 210. Further, the at least one replacement cell of FIG. 2B has less propagation delay for the inputs a and b to the outputs Z₁ and Z₂ than the original cells 208, 206, 212, and 210. The at least one replacement cell of FIG. 2B has approximately the same propagation delay for the inputs d and e to the output Z₂ as the original cells 208, 206, 212, and 210, and may have greater propagation delay for the input c to the output Z₁ than the original cells 208, 206, 212, and 210. For another example, referring to FIG. 2C, the synthesis tool may replace the original cells 208, 206, 212, and 210 (four cells) with one to three cells that include the NAND gate 262, NOR gate 264, and NAND gate 266 interconnected as shown in the diagram 260. The NAND gate 262, NOR gate 264, and NAND gate 266 in the at least one replacement cell may have a size less than or equal to the size of the original cells 208, 206, 212, and 210. Further, the at least one replacement cell of FIG. 2C has less propagation delay for the inputs a and b to the outputs Z₁ and Z₂ than the original cells 208, 206, 212, and 210. The at least one replacement cell of FIG. 2C has approximately the same propagation delay for the inputs d and e to the output Z₂ as the original cells 208, 206, 212, and 210, and approximately the same propagation delay for the input c to the output Z₁ as the original cells 208, 206, 212, and 210.

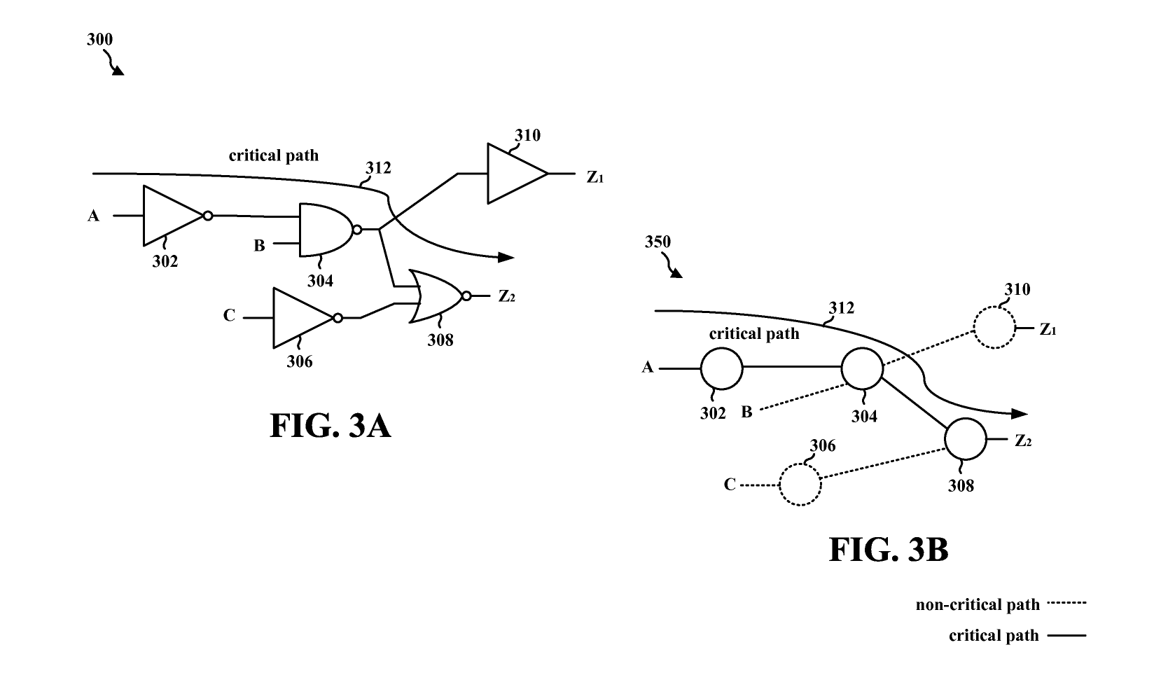

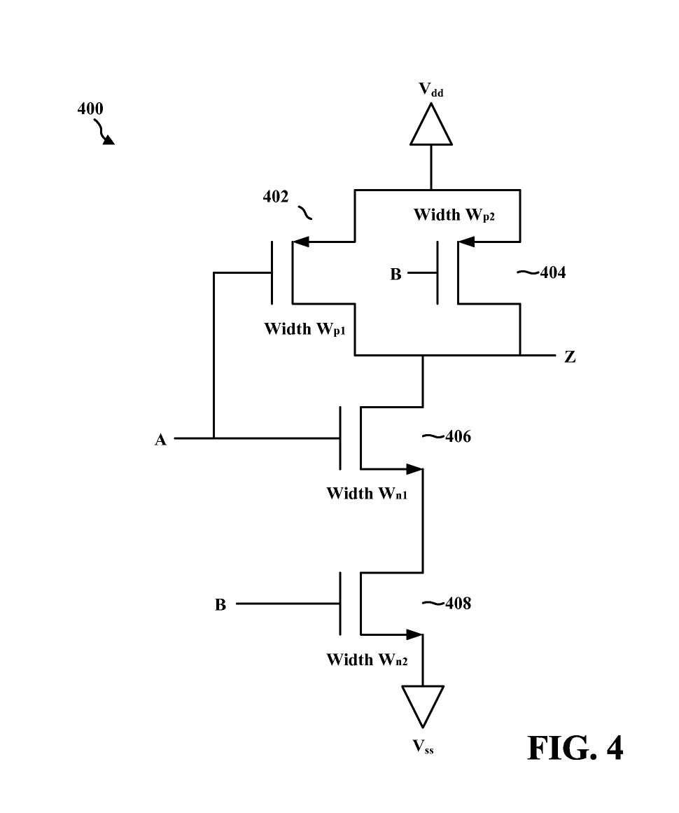

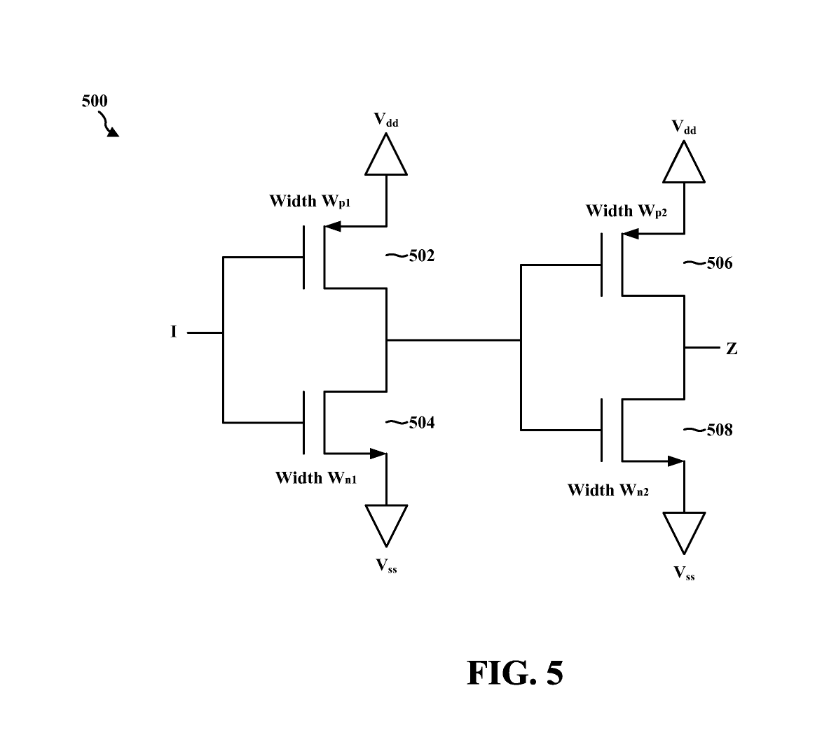

FIGS. 3A and 3B are a second set of diagrams 300, 350 for illustrating an exemplary method of logic synthesis. FIG. 4 is a first circuit diagram 400 for illustrating an exemplary method of logic synthesis. FIG. 5 is a second circuit diagram 500 for illustrating an exemplary method of logic synthesis. Referring to FIG. 3A, signal A is input to an inverter 302, and the inverted signal is input to a NAND gate 304, which also receives input of signal B. The output from the NAND gate 304 is output to both a buffer 310 and a NOR gate 308, which also receives input from the inverter 306 connected to signal C. A synthesis tool may determine that the path 312 from signal A through the inverter 302, NAND gate 304, and NOR gate 308 is a critical path. The synthesis tool may replace the original cells 302, 304; the original cells 302, 304, 308, 310 (including 310 so that there is no fan out of intermediate outputs); or the original cells 302, 304, 306, 308, 310 with at least one replacement cell. In order to reduce the propagation delay for signal A, the at least one replacement cell may include a transistor in a non-critical path with a width less than a corresponding transistor in the original cells. In one configuration, the at least one replacement cell includes the same logic elements as in the original cells, and a transistor width of a transistor in a first logic element in the at least one replacement cell is less than a transistor width of a corresponding transistor in a second logic element in the original cells. The first logic element and the second logic element provide the same logic function, and the transistor is in a non-critical path.

For example, assume for simplicity that the at least one replacement cell includes the NAND gate 304 and the buffer 310. Referring to FIG. 3B and FIG. 4 (illustrating the NAND gate 304, 400), the NAND gate 400 in the at least one replacement cell may include a transistor 404 in a non-critical path between the NAND gate 304/400 and the buffer 310. The transistor 404 in the non-critical path may have a width less than a corresponding transistor in the original cells. Specifically, referring to FIG. 4, within the NAND gate 400 in the at least one replacement cell, a width wₚ₂ of the p-type metal oxide semiconductor (pMOS) transistor 404 may be reduced, while remaining widths wₚ₁ of the pMOS transistor 402, wₙ₁ of the n-type metal oxide semiconductor (nMOS) transistor 406, and wₙ₂ of the nMOS transistor 408 may remain the same. In one configuration, the width wₚ₂ is reduced to at least half the width wₚ₁ (i.e., wₚ₂/wₚ₁≦0.5). The reduced width of wₚ₂ of the pMOS transistor 404 decreases a gate capacitance of the pMOS transistor 404 and a capacitance at the output Z. The decreased capacitance at the output Z decreases the propagation delay of A when A transitions from high to low while B is high. The reduction of the width of wₚ₂ also reduces the drive strength of the pMOS transistor 404 when B transitions from high to low, and therefore increases a propagation delay of B when B transitions from high to low while A is high. However, by reducing a width of a transistor (e.g., the pMOS transistor 404) in a non-critical path, the at least one replacement cell may decrease a propagation delay in the critical path (e.g., signal A transitioning from high to low while signal B is high) at the cost of increasing a propagation delay in the non-critical path (e.g., signal B transitioning high to low while signal A is high).

Referring to FIGS. 3A, 3B, and 5, in one configuration, in order to decrease a propagation delay through the critical path 312, a synthesis tool may replace the buffer 310, which receives an input from an output of the NAND gate 304, with a buffer 500 that has reduced transistor widths. The replacement buffer 500 has a decreased input capacitance, which decreases a propagation delay for signal transitions on the output Z. The replacement buffer 500 may include one or more transistors 502 and/or 504 with a transistor width less than a corresponding transistor in the original buffer 310. For example, the original buffer 310 may have a transistor with width \tilde{w}ₚ₁ and the replacement buffer 500 may have a corresponding transistor 502 with a width wₚ₁, such that wₚ₁=k*\tilde{w}ₚ₁, where k<1. Alternatively or in addition, the original buffer 310 may have a transistor with width \tilde{w}ₙ₁ and the replacement buffer 500 may have a corresponding transistor 504 with a width wₙ₁, such that wₙ₁=j*\tilde{w}ₙ₁, where j<1. In some configurations, the widths of both of the transistors 502, 504 are reduced and the transistors are reduced by the same proportion in the replacement buffer 500, and therefore j=k. In one configuration, the width wₚ₂ of the transistor 506 and the width wₙ₂ of the transistor 508 may not be reduced from the original buffer 310 or may not be reduced by the same factor as the widths wₚ₁, wₙ₁ of the transistors 502, 504, respectively. In such a configuration, if the original buffer 310 had an optimum stage ratio (e.g., ˜3 stage ratio, where the stage ratio is the output capacitance divided by the input capacitance), the decrease in the transistor widths of the transistors 502, 504 in the replacement buffer 500 may cause the stage ratio of the replacement buffer 500 to be less than optimum and may therefore increase the propagation delay through the buffer 500. However, as the buffer 500 is in a non-critical path, the propagation delay through the buffer 500 may be increased in order to decrease a propagation delay through the critical path 312.

Referring again to FIG. 1, a synthesis tool may determine a plurality of paths, such as a first path with cells 150, 152, 156, and 158; a second path with cells 106, 108, 110, and 112; and a third path with cells 140, 142, and 144. Some of the paths may include identical cells. For example, the cells 106 and 150 may be identical, and the cells 108 and 156 may be identical. If the synthesis tool determines that the cells 106 and 108 are in a critical path, the synthesis tool may replace the cells 106 and 108 (within enclosure 114) with one cell that performs the same function as the cells 106 and 108. If the synthesis tool determines that the cells 150 and 156 are not in a critical path, the synthesis tool may not replace the cells 150 and 156 with one cell that performs the same function as the cells 150 and 156. The one cell that replaces the cells 106 and 108 has an identical function as the cells 150 and 156. Accordingly, a network of logic elements may include a plurality of paths between memory stages. As discussed supra, a network of logic elements may include a first path with cells 150, 152, 156, and 158; a second path with cells 106, 108, 110, and 112; and a third path with cells 140, 142, and 144. The network of logic elements may include at least two cells 150 and 156 that are configured together to perform a logic function. The at least two cells 150 and 156 are in a first path of the plurality of paths of the network of logic elements. The first path is between a first set of memory stages 102, 104. The at least two cells 150 and 156 are identical to the cells 106 and 108. The network of logic elements further includes a cell that is configured to perform the same logic function as the at least two cells 150 and 156. The cell replaced the cells 106 and 108 and is in the second path of the plurality of paths of the network of logic elements. The second path is between a second set of memory stages. As shown, the second set of memory stages includes the memory stages 102, 104. However, the second set of memory stages may be different than the first set of memory stages.

The cell that replaces the cells 106 and 108 may include a set of logic elements. As discussed supra in relation to FIG. 2, each intermediate output of the set of logic elements may be unconnected to any input external to the set of logic elements, and each intermediate output of the at least two cells may be unconnected to any input external to the at least two cells. In one configuration, the set of logic elements includes at least three separate logic elements. For example, as shown in FIG. 2B, if one cell includes the inverter 232, the AND gate 234, and the NAND gate 236, such cell would include three separate logic elements. For another example, as shown in FIG. 2C, if one cell includes the NAND gate 262, the NOR gate 264, and the NAND gate 266, such cell would include three separate logic elements.

In one configuration, at least one logic element in the set of logic elements has at least two transistors arranged in parallel between a source and a node with one of the transistors having a width at least twice a width of an other of the transistors. In addition, gates of the at least two transistors are unconnected to each other. For example, referring to FIG. 4, the replacement NAND gate 400 includes at least two transistors 402 and 404 arranged in parallel between a source (V_{dd}) and a node (output Z), and one of the transistors 402 may have a width wₚ₁ at least twice a width wₚ₂ of an other of the transistors 404 (i.e., wₚ₂/wₚ₁≦0.5). Each of the at least two cells 150 and 156 and the cell that replaces the cells 106 and 108 may have the same height and may be connected to a same power mesh.

In one configuration, at least one logic element in the at least two cells has two or more transistors arranged in parallel between a source and a node with one of the transistors having a width approximately equal to a width of an other of the transistors, gates of the two or more transistors being unconnected to each other. For example, assuming the at least two cells 150 and 156 includes a NAND gate as shown in FIG. 4, the widths wₚ₁, wₚ₂ of the transistors 402, 404 may be approximately equal to each other, while in the one cell that replaces the cells 106 and 108, the widths wₚ₁, wₚ₂ may not be equal to each other due to the decreased width wₚ₂ of the transistor 404 in comparison to the width wₚ₁ of the transistor 402.

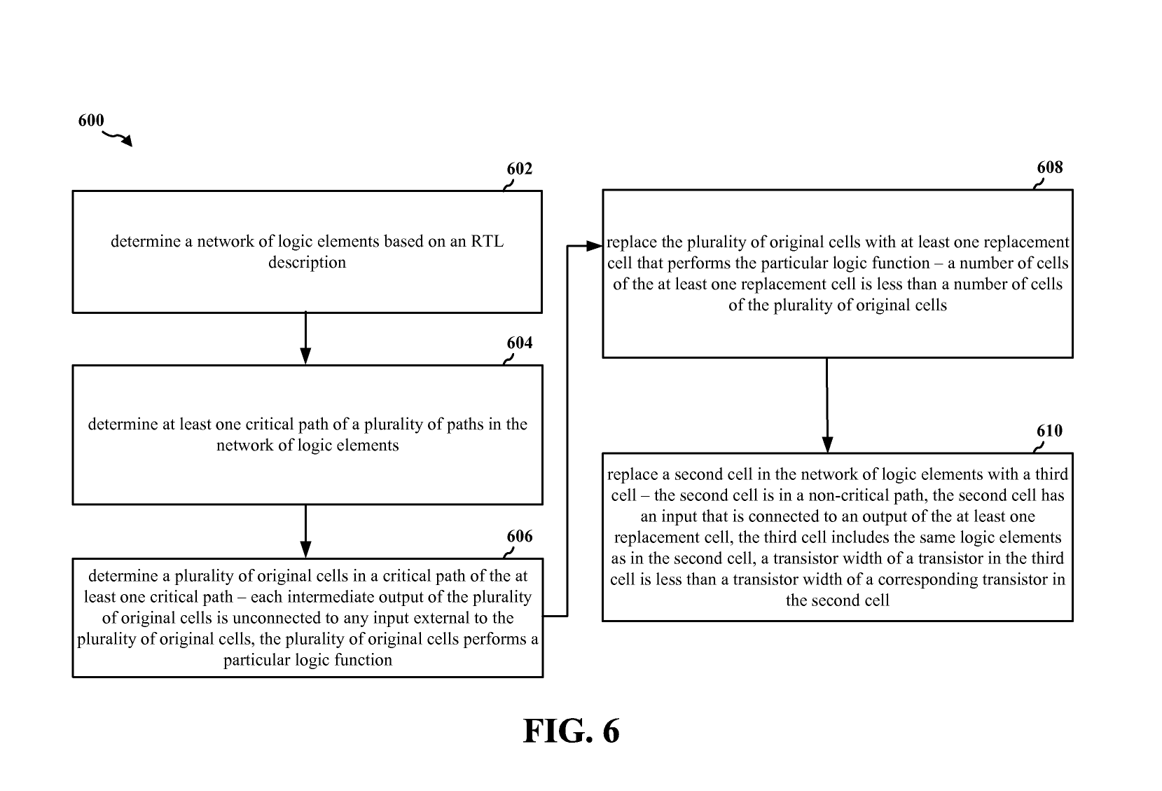

FIG. 6 is a flow chart 600 of an exemplary method. The method may be performed by a synthesis tool. At 602, the synthesis tool determines a network of logic elements based on an RTL description. At 604, the synthesis tool determines at least one critical path of a plurality of paths in a network of logic elements. At 606, the synthesis tool determines a plurality of original cells in a critical path of the at least one critical path. Each intermediate output of the plurality of original cells is unconnected to any input external to the plurality of original cells. The plurality of original cells perform a particular logic function. At 608, the synthesis tool replaces the plurality of original cells with at least one replacement cell that performs the particular logic function. A number of cells of the at least one replacement cell is less than a number of cells of the plurality of original cells.

For example, referring to FIG. 1 and FIG. 2, a synthesis tool determines a network of logic elements 206, 208, 210, 212 based on an RTL description. The synthesis tool determines at least one critical path of a plurality of paths (see FIG. 1) in the network of logic elements. If each of the logic elements 206, 208, 210, 212 is implemented in a cell, the synthesis tool determines that the original cells 206, 208, 210, 212 are in the critical path 214 of the at least one critical path. Each intermediate output of the original cells is unconnected to any input external to the original cells (i.e., there are no fan outs 216 of intermediate outputs of the original cells 206, 208, 210, 212 to inputs external to the original cells 206, 208, 210, 212). The original cells 206, 208, 210, 212 perform a particular logic function (Z₁=a̅b̅+̅c̅; Z₂=a̅b̅d̅e̅). The synthesis tool replaces the original cells 206, 208, 210, 212 with at least one replacement cell that performs the particular logic function. For example, the at least one replacement cell may be one or more cells that include the inverter 232, the AND gate 234, and the NAND gate 236 of FIG. 2B. For another example, the at least one replacement cell may be one or more cells that include the NAND gate 262, the NOR gate 264, and the NAND gate 266 of FIG. 2C. A number of cells of the at least one replacement cell (e.g., three in FIGS. 2B, 2C assuming each logic element is implemented in a different cell) is less than a number of cells of the original cells 206, 208, 210, 212 (four).

As shown in FIG. 1, the plurality of paths may be between a first memory stage and a second memory stage. Alternatively or in addition, the plurality of paths may be between a memory and a register, a register and a memory, or two registers. Each of the at least one critical path may have a delay greater than a delay threshold. As discussed supra, the at least one replacement cell may have the same size or a smaller size than a combined size of the plurality of original cells.

Referring to FIGS. 3A, 3B, 4, and 5, the at least one replacement cell may include a transistor (e.g., pMOS transistor 404) in a non-critical path with a width wₚ₂ less than a corresponding transistor in the plurality of original cells. The critical path in the at least one replacement cell may have a lower propagation delay than the critical path in the plurality of original cells due at least in part to the transistor. The at least one replacement cell may include the same logic elements as in the plurality of original cells, and a transistor width of a transistor in a first logic element in the at least one replacement cell may be less than a transistor width of a corresponding transistor in a second logic element in the plurality of original cells. The first logic element and the second logic element may provide the same logic function. The transistor may be in a non-critical path. The synthesis tool may replace a second cell (e.g., the buffer 310) in the network of logic elements with a third cell (e.g., the buffer 500). The second cell may be in a non-critical path. The second cell may have an input that is connected to an output of the at least one replacement cell. The third cell may include the same logic elements as in the second cell. A transistor width of a transistor (e.g., pMOS transistor 502 and/or nMOS transistor 504) in the third cell may be less than a transistor width of a corresponding transistor in the second cell.

In one configuration, an apparatus such as a synthesis tool may include means for determining at least one critical path of a plurality of paths in a network of logic elements. The apparatus further includes means for determining a plurality of original cells in a critical path of the at least one critical path. Each intermediate output of the plurality of original cells is unconnected to any input external to the plurality of original cells. The plurality of original cells perform a particular logic function. The apparatus further includes means for replacing the plurality of original cells with at least one replacement cell that performs the particular logic function. A number of cells of the at least one replacement cell is less than a number of cells of the plurality of original cells. The apparatus may further include means for replacing a second cell in the network of logic elements with a third cell. The second cell may be in a non-critical path. The second cell may have an input that is connected to an output of the at least one replacement cell. The third cell may include the same logic elements as in the second cell. A transistor width of a transistor in the third cell may be less than a transistor width of a corresponding transistor in the second cell. The apparatus may further include means for determining the network of logic elements based on an RTL description. In one configuration, the apparatus may be a processor configured to perform each of the means, and specifically a special purpose computer programmed to perform the disclosed algorithm corresponding to each of the means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of logic synthesis, comprising:
determining at least one critical path of a plurality of paths in a network of logic elements;
determining a plurality of original cells in a critical path of the at least one critical path, each intermediate output of the plurality of original cells being unconnected to any input external to the plurality of original cells, the plurality of original cells performing a particular logic function; and
replacing the plurality of original cells with at least one replacement cell that performs the particular logic function, a number of cells of the at least one replacement cell being less than a number of cells of the plurality of original cells.

2. The method of claim 1, wherein the plurality of paths are between a first memory stage and a second memory stage, and each of the at least one critical path has a delay greater than a delay threshold.

3. The method of claim 1, wherein the at least one replacement cell is a same size or a smaller size than a combined size of the plurality of original cells.

4. The method of claim 1, wherein the at least one replacement cell includes a transistor in a non-critical path with a width less than a corresponding transistor in the plurality of original cells, the critical path in the at least one replacement cell having a lower propagation delay than the critical path in the plurality of original cells due at least in part to the transistor.

5. The method of claim 1, wherein the at least one replacement cell includes a same logic elements as in the plurality of original cells, and a transistor width of a transistor in a first logic element in the at least one replacement cell is less than a transistor width of a corresponding transistor in a second logic element in the plurality of original cells, the first logic element and the second logic element providing a same logic function, the transistor being in a non-critical path.

6. The method of claim 1, further comprising replacing a second cell in the network of logic elements with a third cell, the second cell being in a non-critical path, the second cell having an input that is connected to an output of the at least one replacement cell, the third cell including a same logic elements as in the second cell, a transistor width of a transistor in the third cell being less than a transistor width of a corresponding transistor in the second cell.

7. The method of claim 1, further comprising determining the network of logic elements based on a register transfer level (RTL) description.

8. An apparatus for logic synthesis, comprising:
means for determining at least one critical path of a plurality of paths in a network of logic elements;
means for determining a plurality of original cells in a critical path of the at least one critical path, each intermediate output of the plurality of original cells being unconnected to any input external to the plurality of original cells, the plurality of original cells performing a particular logic function; and
means for replacing the plurality of original cells with at least one replacement cell that performs the particular logic function, a number of cells of the at least one replacement cell being less than a number of cells of the plurality of original cells.

9. The apparatus of claim 8, wherein the plurality of paths are between a first memory stage and a second memory stage, and each of the at least one critical path has a delay greater than a delay threshold.

10. The apparatus of claim 8, wherein the at least one replacement cell is a same size or a smaller size than a combined size of the plurality of original cells.

11. The apparatus of claim 8, wherein the at least one replacement cell includes a transistor in a non-critical path with a width less than a corresponding transistor in the plurality of original cells, the critical path in the at least one replacement cell having a lower propagation delay than the critical path in the plurality of original cells due at least in part to the transistor.

12. The apparatus of claim 8, wherein the at least one replacement cell includes a same logic elements as in the plurality of original cells, and a transistor width of a transistor in a first logic element in the at least one replacement cell is less than a transistor width of a corresponding transistor in a second logic element in the plurality of original cells, the first logic element and the second logic element providing a same logic function, the transistor being in a non-critical path.

13. The apparatus of claim 8, further comprising means for replacing a second cell in the network of logic elements with a third cell, the second cell being in a non-critical path, the second cell having an input that is connected to an output of the at least one replacement cell, the third cell including a same logic elements as in the second cell, a transistor width of a transistor in the third cell being less than a transistor width of a corresponding transistor in the second cell.

14. The apparatus of claim 8, further comprising means for determining the network of logic elements based on a register transfer level (RTL) description.

15. An apparatus for logic synthesis, comprising:
a memory; and
at least one processor coupled to the memory and configured to:
determine at least one critical path of a plurality of paths in a network of logic elements;
determine a plurality of original cells in a critical path of the at least one critical path, each intermediate output of the plurality of original cells being unconnected to any input external to the plurality of original cells, the plurality of original cells performing a particular logic function; and
replace the plurality of original cells with at least one replacement cell that performs the particular logic function, a number of cells of the at least one replacement cell being less than a number of cells of the plurality of original cells.

16. The apparatus of claim 15, wherein the plurality of paths are between a first memory stage and a second memory stage, and each of the at least one critical path has a delay greater than a delay threshold.

17. The apparatus of claim 15, wherein the at least one replacement cell is a same size or a smaller size than a combined size of the plurality of original cells.

18. The apparatus of claim 15, wherein the at least one replacement cell includes a transistor in a non-critical path with a width less than a corresponding transistor in the plurality of original cells, the critical path in the at least one replacement cell having a lower propagation delay than the critical path in the plurality of original cells due at least in part to the transistor.

19. The apparatus of claim 15, wherein the at least one replacement cell includes a same logic elements as in the plurality of original cells, and a transistor width of a transistor in a first logic element in the at least one replacement cell is less than a transistor width of a corresponding transistor in a second logic element in the plurality of original cells, the first logic element and the second logic element providing a same logic function, the transistor being in a non-critical path.

20. The apparatus of claim 15, wherein the at least one processor is further configured to replace a second cell in the network of logic elements with a third cell, the second cell being in a non-critical path, the second cell having an input that is connected to an output of the at least one replacement cell, the third cell including a same logic elements as in the second cell, a transistor width of a transistor in the third cell being less than a transistor width of a corresponding transistor in the second cell.

21. The apparatus of claim 15, wherein the at least one processor is further configured to determine the network of logic elements based on a register transfer level (RTL) description.

22. A metal oxide semiconductor (MOS) device, comprising:
a network of logic elements including a plurality of paths between memory stages;
at least two cells that are configured together to perform a logic function, the at least two cells being in a first path of the plurality of paths of the network of logic elements, the first path being between a first set of memory stages; and
a cell that is configured to perform a same logic function as the at least two cells, the cell being in a second path of the plurality of paths of the network of logic elements, the second path being between a second set of memory stages.

23. The MOS device of claim 22, wherein the cell includes a set of logic elements, each intermediate output of the set of logic elements is unconnected to any input external to the set of logic elements, and each intermediate output of the at least two cells is unconnected to any input external to the at least two cells.

24. The MOS device of claim 23, wherein the set of logic elements includes at least three separate logic elements.

25. The MOS device of claim 23, wherein at least one logic element in the set of logic elements has at least two transistors arranged in parallel between a source and a node with one of the transistors having a width at least twice a width of an other of the transistors, gates of the at least two transistors being unconnected to each other.

26. The MOS device of claim 22, wherein each of the at least two cells and the cell have a same height and are connected to a same power mesh.

27. The MOS device of claim 22, wherein at least one logic element in the at least two cells has two or more transistors arranged in parallel between a source and a node with one of the transistors having a width approximately equal to a width of an other of the transistors, gates of the two or more transistors being unconnected to each other.
